(19) United States
(12) Patent Application Publication
(10) Pub. No.: US 2005/0087424 A1
(43) Pub. Date: Apr. 28, 2005

(54) Mass transit bus fare box

(75) Inventors: Matthew J. Newsome, Bonita, CA (US); Jeffrey S. Brumfield, San Diego, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Cubic Corporation, San Diego, CA (US)

(21) Appl. No.: 10/948,623

(22) Filed: Sep. 22, 2004

Related U.S. Application Data
(60) Provisional application No. 60/504,899, filed on Sep. 22, 2003.

(51) Int. Cl. G07D 5/08

(52) U.S. Cl. 194/320

(57) ABSTRACT

A classifying farebox houses a bill unit which quickly accepts bills and coins from a patron, determines most probably currency denomination, and deposits the currency in a windowed area of the farebox for driver verification. Since the classifying farebox determines denomination, the driver does not need to make any entry of deposited fare value to support the fare product. However, via the window, the driver has the opportunity to look at the bills to determine if patrons have inserted fraudulent bills.

### CROSS-REFERENCES TO RELATED APPLICATIONS

This application claims priority to U.S. Provisional Application No. 60/504,899 (Attorney Docket No. 014801-003500US) filed Sep. 22, 2003 and is herein incorporated by reference for all purposes.

### FIELD OF THE DISCLOSURE

Disclosed is an automatic fare collection device and, more specifically, a fare collection device used for accepting bills and coins for payment of mass transit fares.

### BACKGROUND OF THE DISCLOSURE

Fare collection on U.S. buses is primarily achieved utilizing a bus farebox. The farebox is designed to collect money, i.e., bills and coins, as fare payment for a trip on, for example, a bus of a mass transit system. The fare may be paid by the patron in the form of paper media, magnetic media, contactless smart card media or currency. The prior solution to money collection is defined by two types of fareboxes, namely, registering fare boxes and validating fare boxes.

A registering farebox focuses on the size of the media inserted in the box. For coins, a registering farebox measures coin diameter. For bills, a registering farebox measures length. All inserted coins and bills are then moved to a window which faces the bus driver so he can look at the inserted media. At this point, it is up to the driver to insure that the currency presented is not counterfeit. The farebox “registers” the supposed value of the received currency, and indicates the value on a driver's display. A disadvantage of the registering farebox is that slugs can count as coins if their diameters correspond to real coins. Similarly, any piece of paper that is the same length as a dollar bill will count as a dollar bill. Therefore, a driver must visually confirm that the media in the viewing window is valid.

A further disadvantage of the registering farebox is that change or deposited monies cannot be returned to the patron. Also, the registering farebox cannot tell the difference between different denominations of bills since they are all the same length. Thus, the driver must reclassify a deposited bill from the default value of $1 to a $5, $10 or $20 bill.

A validating farebox focuses on the detailed properties of the inserted media. For coins, a sensor measures metallic content of inserted coins to differentiate between coins and to identify fraudulent ones, e.g., slugs. For bills, a device with an array of sensing capabilities looks for color, signatures, etc., of the bills to determine both denomination and validity, that is, detection of fraudulent bills. If the bills or coins are determined to be invalid, they are returned to the patron who must either attempt a second insertion, or insert alternate bills and/or coins. Since the validating farebox determines the validity and the denomination of the inserted currency, the driver does not need to monitor the fares.

Validating fareboxes have gained popularity in the past few years since bus operators can reduce the intake of fraudulent bills and coins. In addition, patrons can pay with higher denomination bills. Validating fare boxes also greatly reduce the risk of monetary loss by the transit system when a patron wishes to add value to a fare card or buy fare products on the bus since the currency is validated.

The validating solution has created two fundamental problems. First, the bill and coin validation has added significant time to the process of buying a fare. This creates long lines (queues) on the bus which may affect schedules. Secondly, the validating circuits greatly reduced the reliability of the farebox device. Where a registering farebox is made of simple parts that move the money, the validating farebox uses complex components which have a lower reliability.

Transit authorities continue to have interest in selling different fare products on buses without having to deal with issues of fraud and slow service. The registering fareboxes and validating fareboxes do not offer acceptable solutions.

### BRIEF SUMMARY OF THE DISCLOSURE

A classifying farebox unit (CFU) of the exemplary embodiment is an electro-mechanical device that accepts, processes and validates coins, classifies bills by denomination, and processes magnetic and smart card fare media. The CFU provides operational simplicity and reliability. Modular construction is employed in the unit to achieve ease of maintenance and repair. The CFU meet all automatic fare collection (AFC) fare media processing requirements in use today in addition to Type A and Type B smart cards. All farebox functionality is controlled by a driver control unit (DCU), which provides data processing, driver display, and driver keypad functions. Power is supplied to the classifying farebox and the driver control unit from the bus.

The CFU is installed adjacent to the bus driver's position. As patrons board a bus, the CFU accepts fare payment in the form of bills, coins, tokens, and various types of magnetic and smart card fare media. The CFU also issues magnetic transfers. Transaction data and summary data are captured and stored in non-volatile memory within the driver control unit. Stored transaction and summary data are later uploaded to a farebox probing computer (FPC) and forwarded to the farebox central system (FCS) for processing and report generation.

The classifying farebox bridges the gap between a registering farebox and a validating farebox. One of the primary premises for utilizing a classifying farebox rather than a validating farebox is that the need in the bus market is not to avoid counterfeits, which are rare in that environment, but to quickly and reliably classify bills by value and process large quantities of coins. The classifying farebox houses a bill unit which quickly accepts bills from a patron, determines their denomination and deposits them in a driver window for visual verification. An array of sensors of the bill unit looks at certain points on the inserted bills. The output signals of these sensors are analyzed in software to determine which type/denomination of bill has been inserted. The device may not return bills to the patron, nor may it validate the bill to allow the unit to move the bill quickly from the input bezel to the bill viewing window. Since the CFU determines the denomination of the bill, the driver does not need to make any entry to support the fare product. The driver need only look at the inserted bills via a bill viewing window to determine if patrons have inserted fraudulent bills.

The classifying farebox unit provides all of the essential operational characteristics of a validating farebox, but at a reduced cost. In addition, the fast processing of bills does not slow down patron boards, and the ability of the CFU to differentiate denominations supports the bus operator's objective to sell and add value to a variety of fare products without the driver having to input values each time money is inserted. The classifying farebox of the present disclosure includes coin singulation to simplify and accelerate coin processing and patron boarding, as well as coin identification and validation using inductive sensing for metallic content. A coin/bill display window provides visual verification of fare, if necessary. The classifying farebox also incorporates automatic bill denomination recognition and acceptance and centralized farebox control using the driver control unit, which provides processing, display and driver keypad capabilities in a single integrated unit.

### BRIEF DESCRIPTION OF THE DRAWINGS

The present invention will be better understood from the following detailed description of a preferred embodiment of the invention, taken in conjunction with the accompanying drawings in which like reference numerals refer to like parts.

FIG. 1 is an illustration of a classifying farebox unit of the preferred embodiment of the present invention.

FIG. 2a is an illustration the driver control unit of a classifying farebox.

FIG. 2b is an illustration of the exterior driver side view of the classifying farebox.

FIG. 2c is an illustration of the exterior right side view of the classifying farebox.

FIG. 3a illustrates the top view of the classifying farebox.

FIG. 3b is an illustration of the patron side view of the classifying farebox.

FIG. 4 is an illustration of a smart card reader of the preferred embodiment of the invention.

FIG. 5 is an illustration of the driver control unit front panel.

FIG. 6 shows a smart input output unit of a classifying farebox of the present invention.

FIG. 7 is an illustration of an idle screen of the driver control unit of the classifying farebox.

FIG. 8 illustrates a driver control unit lighting and volume controls screen.

FIG. 9 is an illustration of a main revenue screen of a driver control unit.

FIG. 10 illustrates a bill override screen of a driver control unit.

FIG. 11 is an illustration of a bypass indication of a driver control unit.

FIG. 12 illustrates a trip change screen of a driver control unit.

FIG. 13 shows a portable data probe for use with a classifying farebox of the present invention.

FIG. 14 illustrates a receiver/vault for use with a classifying farebox of the present invention.

FIG. 15 is an illustration of a mobile vault for use with a classifying farebox of the present invention.

FIG. 16 is a view of an alternative embodiment showing the exterior driver's side view of the classifying farebox.

FIG. 17 illustrates an alternative embodiment illustrating the exterior patron side view of the classifying farebox.

FIG. 18 is a top view of the alternative embodiment shown in FIG. 16 of the classifying farebox, with the lid closed.

FIG. 19 is a top view of the alternative embodiment shown in FIG. 16 of the classifying farebox, with the lid open.

FIG. 20 illustrates a cross-sectional view taken from line 20-20 from FIG. 16 of the alternative embodiment of the classifying farebox.

FIG. 21 is a cross-sectional view taken from line 21-21 from FIG. 16 of the alternative embodiment of the classifying farebox.

FIG. 22 is a flow chart of the method of operation of the classifying farebox of the present disclosure.

### DETAILED DESCRIPTION OF THE DISCLOSURE

The following detailed description utilizes a number of acronyms which are generally well known in the art. While definitions are typically provided with the first instance of each acronym, for convenience, Table 1 below provides a list of the acronyms and abbreviations and their respective definitions.

TABLE 1

| Acronym | Definition |
|---|---|
| AFC | Automatic Fare Collection |
| CAD/AVL | Computer Aided Dispatching/Automatic Vehicle Location |
| CCTV | Closed Circuit Television |
| CFU | Classifying Farebox Unit |
| DCU | Driver Control Unit |
| EMI | Electro-magnetic Interference |
| EPROM | Erasable Programmable Read Only Memory |
| FCS | Farebox Central System |
| FPC | Farebox Probing Computer |
| I/O | Input/Output |
| IFU | Integrated Fare Unit |
| LCD | Liquid Crystal Display |
| LED | Light Emitting Diode |
| MCBF | Mean Cycles Between Failures |
| MPU | Magnetic Processor Unit |
| POS | Point of Sale |
| USB | Universal Serial Bus |
| WAP | Wireless Access Point |

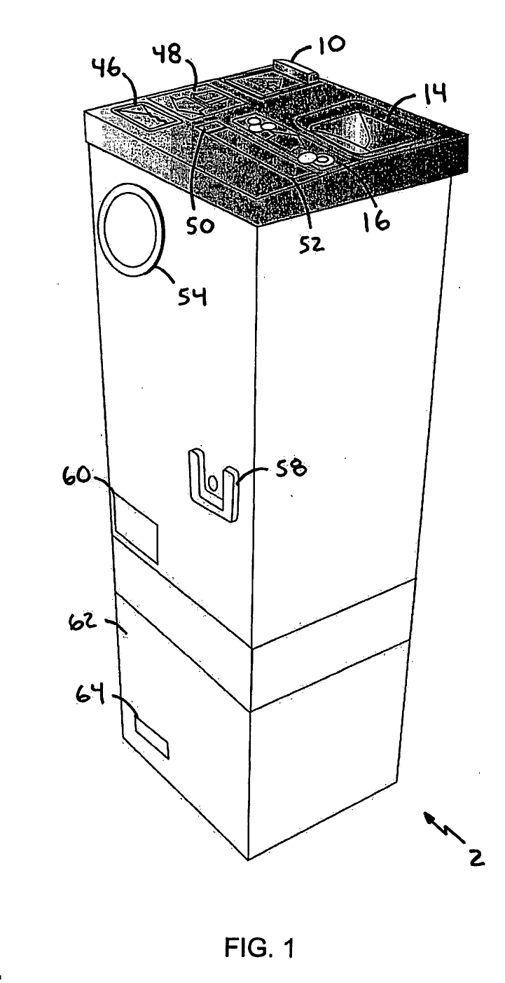

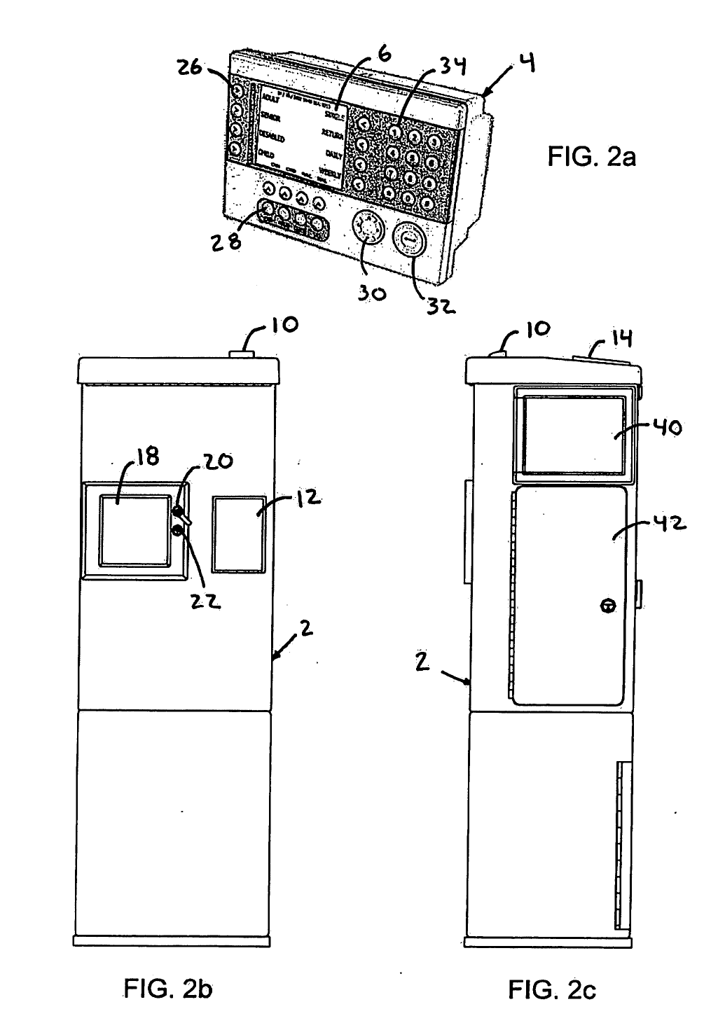

The classifying farebox unit (CFU) 2 illustrated in FIG. 1 is a high reliability integrated fare unit (IFU). The CFU 2 is a fare-collection device used on buses to validate and accept all U.S. coins (except, in some circumstances, the 50¢ piece and silver dollar) and tokens, to classify and accept bills by denomination ($1, $5, $10, and $20, by way of example), and to read from/write to fare card media. The types of fare cards accepted include smart cards and paper and plastic magnetic cards, e.g., change card, transfer, permit, employee pass, stored value and stored ride card, period pass. Monies collected are securely transferred into a cashbox within the CFU 2 for later transfer to a receiver/vault. The CFU 2 processes and records various types of fare transactions using a set of driver-activated pushbutton controls 26, 28, 30, 32, 34 on a driver control unit (DCU) 4, illustrated in FIG. 2a. Data collected relative to operational performance are stored in memory and transmitted to a farebox probing computer (FPC), as discussed further below, via a wireless data transfer capability of the DCU 4.

The classifying farebox unit 2 of an exemplary embodiment is contained in a cabinet having a width of 12.0 inches, a height of 36-inches, and a depth of 10.5 inches. The unit 2 is located adjacent to the bus driver and is designed so that boarding patrons may easily insert the required fare into the unit 2. The CFU design allows the driver to visually inspect the inserted coin and/or bill fare via inspection windows 12, 18 in the farebox, to observe the digital readouts provided on the DCU display 6, and to reach and activate the various controls 26, 28, 30, 32, 34 provided to accept and record the fare.

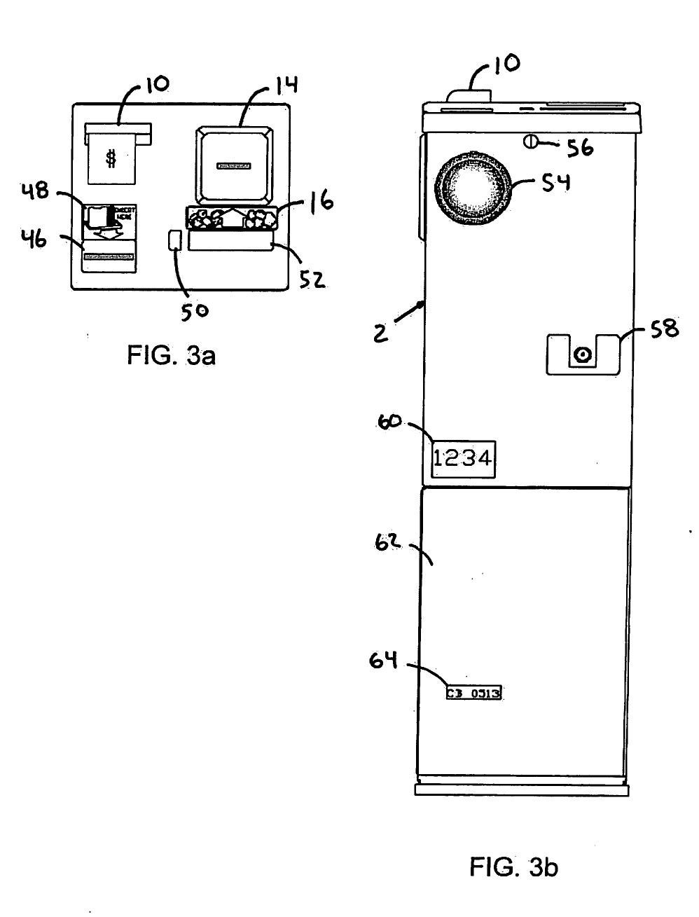

FIGS. 3a and 3b show a top view and a patron side view of the classifying farebox 2, shown in FIG. 1 in an isometric view. Referring to FIG. 3a, a patron must deposit coins in the coin bezel 14. A coin decal 16 is provided to prompt the patron and to identify the coins accepted by the farebox. A customer display 52 indicates the fare deposited or the status of transaction. The transaction status lights 50 verifies a patron transaction status. For example, a green light indicates “Go” for a valid transaction, and a red light indicates “No Go” for an invalid transaction. A magnetic processor unit (MPU) decal 48 identifies how to insert farecards, tickets and transfers into the MPU via the MPU bezel 46. A bill bezel 10 indicates where and how bills are to be entered.

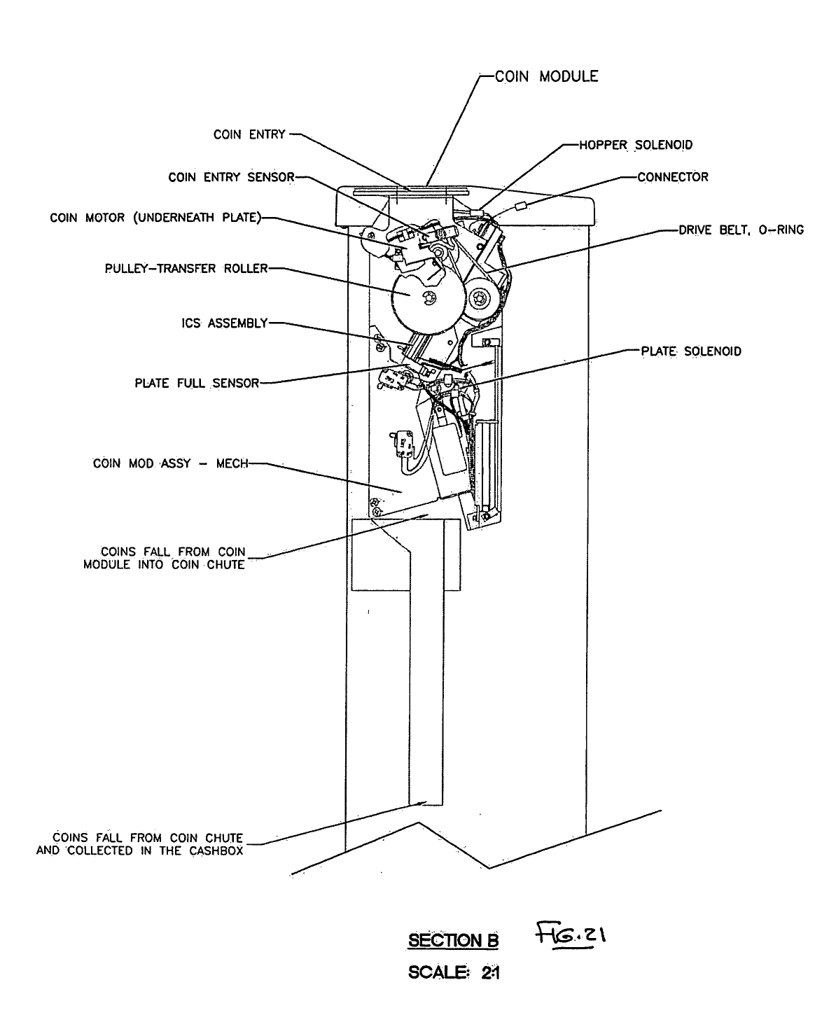

As illustrated in FIG. 3b, the patron side of the classifying farebox 2 includes a farebox top cover lock 56 which is a high security lock that allows access to the internal parts of the farebox. FIG. 18 illustrates the top view with the farebox cover closed, and FIG. 19 illustrates a top view with the farebox cover open and with the farebox cover lock 56 in the unlocked position. A smart card target 54 is the target antenna for the smart card processor. A probe port 58 is an inductive communications port used to transfer a door unlock signal to the farebox, which is identified by a farebox number 60. A cashbox door 62 allows controlled access to the cashbox inside of the unit 2, and can only be opened during revenue service procedure. A cashbox number 64 identifies the number of the cashbox present in the farebox 2.

FIG. 2a illustrates the driver control unit (DCU) 4 of the preferred embodiment of the present invention. The DCU houses a display 6 and a variety of keys for the driver's use. The driver display 6 shows functions that may be executed by the driver, data entered by driver, messages, fares deposited and the status of deposited media. Soft keys 26, function keys 28, a navigation key 30, an enter key 32 and numeric keypad 34 allows the driver to select a function presented on the display, enter information into the DCU and to operate the farebox 2.

FIGS. 2b and 2c illustrate the driver side and right side views of the classifying farebox unit 2. A coin bypass 20 permits collection of coins when the coin module is jammed and/or defective. When the coin bypass 20 is used, the driver control unit display 6 reads “Bypass”. The farebox does not count coins in Bypass. A coin viewing window 18 permits the driver to view, verify and/or count coins deposited in the coin bezel 14. The de-jam button 22 loosens jams in the coin mechanism and starts an automatic de-jam function. The driver views and verifies deposited bills through the bill viewing window 12. The magnetic processor unit (MPU) access door 40 provides access to the MPU transport to clear jams. Magnetic ticket stock door 42 provides access to magnetic ticket stock rolls.

The classifying farebox is a highly reliable classifying farebox and is shown in FIG. 1 a fare-collection device used on buses to validate all U.S. coins, and tokens. Monies collected are securely transferred into a cashbox inside of the unit 2 for later transfer to a receiver vault. The farebox 2 also issues or accepts various types of magnetic and smart card bus tickets with a format compatible with existing automatic fare collection systems. The farebox records various types of fare transactions using a set of driver-activated pushbutton controls on the driver control unit 4, shown in FIG. 2a. Data collected relative to operational performance is stored in memory in the CFU 2 and transmitted to a farebox probing computer via a wireless data probing capability.

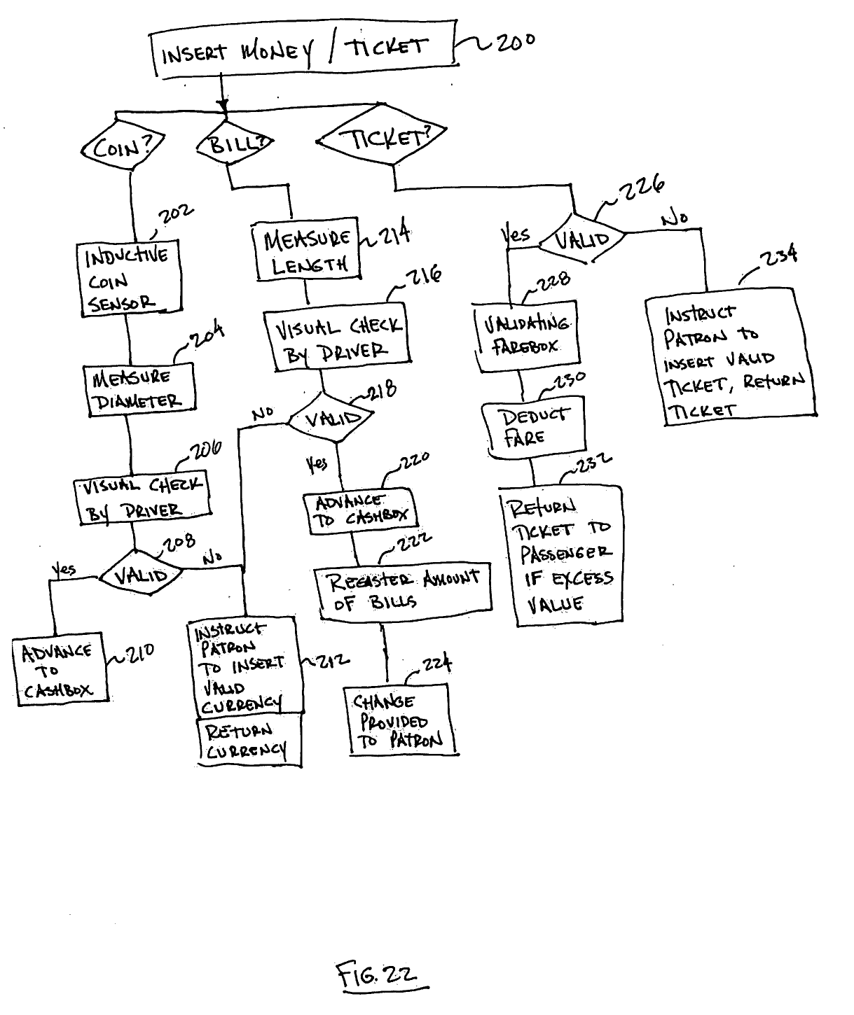

The Magnetic Processor Unit (MPU), also known as the ticket processing unit, shown in FIG. 20 as item 110, is contained within the classifying farebox 2 and validates, encodes, and prints magnetic tickets. The magnetic ticket may also serve as evidence that the passenger has paid his/her fare. The MPU issues and accepts magnetic fare media such as transfers, stored-ride, stored value, and passes. A count by fare media type or transfer is stored by the farebox for each transaction. The MPU is microprocessor controlled and includes a ticket transport and two rolls of ticket stock for the issue of tickets. This equipment reads, writes, and verifies magnetic data and prints tickets and transfers issued by the MPU. An entry bezel 46 is located at the top of the farebox unit 2 for the insertion and removal of tickets by patrons. The transport handles tickets in the most expedient manner. The entry bezel 46 is of sufficient size and shape to minimize the insertion of incorrect fare media. The ticket entry bezel 46 is easily accessible to patrons boarding the bus. The MPU is an integral part of the farebox. It is a plug-in module and is easily removed without special tools.

The MPU is accompanied by a prompting decal 48, which provides visual instructions to the patron for the correct insertion of magnetic cards/tickets into the MPU. Magnetic data are read, verified, processed, decremented (if applicable) and re-encoded on the ticket. The driver display 6 on the DCU 4 shows the fare media status, if valid, and the reason for rejection, if invalid. In the preferred embodiment of the invention, ticket processing time is less than two seconds per transaction. The MPU issues transfers fully encoded and printed with valid data within one and a half seconds. The driver depresses the appropriate push button on the farebox DCU 4 to issue transfers with correct coding for each fare type.

The MPU accepts, verifies, and displays not less than twenty (20) different ticket types at any given time, each of which has a current validity. The farebox DCU processor can be programmed for acceptable ticket types and their validity periods by means of the downloading of data to the DCU during normal wireless farebox probing and via portable data unit data ports. One trip is deducted from the ticket upon acceptance of multi-ride tickets. Transfer acceptance parameters are downloadable from the farebox central system (FCS) via the FPC during normal wireless probing.

Operation of the MPU is initiated when the patron inserts a magnetic fare card into the ticket bezel 46. The ticket is continuously gripped and positively fed through the ticket handling mechanism at all times. The transport mechanism does not adversely affect the magnetic material or the data recorded on the data track. The movement of a magnetic ticket is monitored by the farebox logic to detect failure of a card/ticket to traverse the mechanism properly.

Each magnetic ticket is read and checked for validity. If the ticket is determined to be invalid and is rejected by the MPU, “INVALID TICKET” is displayed on the DCU 4 and patron displays 50 and 52, and the ticket is immediately returned to the patron. The following data are checked for validity of the magnetic ticket:
Expiration Date: The MPU logic verifies that the expiration encoded on the ticket is not earlier than the present date for all tickets;
Fare Category: The MPU logic verifies that the fare category encoded on the ticket is valid for all tickets;
Transfer Information: When a transaction involves a transfer, the expiration date, time and route are checked by the MPU logic to verify validity;
Passback: The MPU verifies that the ticket or pass has not been used in the last sixty (60) minutes (or other downloadable time period) for all passes/tickets; and if valid for transfer (settable for on or off, systemwide); and
Hotlist: The MPU verifies that the ticket or pass serial number is not on the hotlist, (invalid card list).

Following completion of the transaction, the ticket passes by the write head of the MPU where the applicable data are encoded. It then passes by the read head to verify that the data have been re-encoded properly. If there is no error detected in verifying the data, the ticket is transported back/out through the insert slot 46 where it remains until retrieved by the patron. If an error is detected during verification of the data, a second and possibly a third attempt is automatically made to correctly write and verify the encoded data. If the error persists, the patron is informed of the problem and the ticket is returned to the patron.

An exemplary embodiment of the present disclosure utilizes a single line dot matrix printer for printing on paper ticket roll stock, rather than thermal printing. Those skilled in the art will appreciate that any other printing means may be utilized, such as thermal printing or the like. Transfers are printed with the date and time of issuance, route number, and bus number. Two rolls of ticket/transfer stock are provided with a capacity of approximately 500 tickets each. Switching between the two rolls of transfer stock is automatic, when one roll is expended. The farebox allows for convenient access to the ticket stock rolls by way of an access door. A low stock message alerts the driver of the condition. A separate MPU printer ribbon access door is also provided.

Transit authorities around the world must have the flexibility for interoperability with multiple card types, including those types available now as well as those that will evolve in the future from a variety of manufacturers. Thus, the classifying farebox 2 includes a smart card processing products based on Cubic's Tri-Reader technology as disclosed in U.S. Pat. No. 6,577,229 (the '229 patent), incorporated herein by reference in its entirety. The Tri-Reader technology is the first truly open architecture multi-protocol contactless smart card reader/writer capable of supporting the full range of ISO 14443 compliant cards in a completely seamless manner. It has demonstrated its ability to process all available cards that truly conform to the ISO 14443 International Standards in addition to Cubic's GO CARD that is used in Washington, D.C. and Chicago, and Los Angeles in the near future.

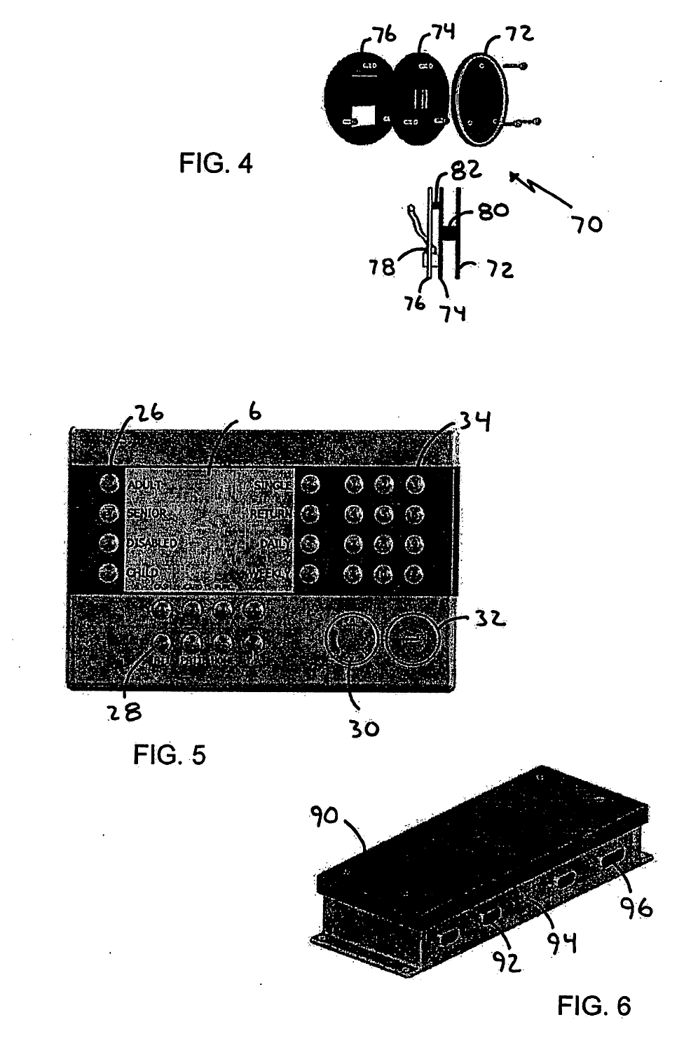

FIG. 4 illustrates the smart card Tri-Reader•2 that is utilized in an exemplary embodiment of the present disclosure of the smart card processor. This next generation advanced RISC processor-based module is a miniaturized and fully integrated version of the Tri-Reader and master module as disclosed in the '229 patent, but with simplified/limited I/O facilities and slightly reduced memory storage capability. The Tri-Reader•2 is especially well suited for application in a bus farebox that contains its own bus host processor (DCU). It contains sufficient processing power to support the transit application, manage the smart card and central system communications security functions and provide transaction store and forward functions. As shown in FIG. 4, the reader includes an antenna board 72 connected to a controller board 74 via a connector 80. An expansion connector 82 on the controller board 74 allows the addition of an optional expansion module 76, if necessary.

The smart card processor 70 reads a smart card when it is touched to the target antenna 54, executes the required transaction, and re-encodes the remaining value on the card within approximately 300 milliseconds. All transaction data is forwarded to the DCU 4 for retention and uploading to the FPC during normal wireless probing as the bus enters a transit garage facility.

Referring again to FIG. 3a, an exemplary embodiment of the present disclosure utilizes a bill module which accepts bills in any orientation and classifies the bill by denomination. An internal view of the bill module is illustrated in FIG. 20. The bill module can accept, identify, count, and securely store paper currency based on optical and magnetic characteristics without driver intervention. The bill acceptor is mounted in the upper portion of the farebox 2 with an entry bezel 10 in the top lid for easy insertion of currency. The bill acceptance slot 10 is near the coin slot 14 and accepts bills opened to their full area and inserted lengthwise. A green light on the indicator 50 means that it is ready to accept bills. A red light means it is not ready to accept bills. The bill slot 10 is illuminated and provided with a guide plate to facilitate insertion of bills while deterring the accidental insertion of coins. The acceptor grips an inserted bill in a positive manner and does not require precise insertion by the patron. Bills must be inserted approximately one-half inch before the transport mechanism engages the bill. No force is required to cause the mechanism to start.

The acceptor can accept an inserted bill in any one of four orientations: face up, face down, either end first. The acceptor can process the following seven U.S. banknotes in “street” condition, including wrinkled, torn, folded, or damp currency: one-dollar bills ($1); five-dollar bills ($5), old and new style; ten-dollar bills ($10), old and new style; and twenty-dollar bills ($20), old and new style. Any media that fails to be classified will be advanced to the viewing window. The bus driver inspects the media and classifies the bill using the DCU keypad 34. The DCU 4 maintains counts of bills that are manually classified.

The bill module feeds an accepted bill into a currency transport that progresses the bill into the driver-viewing window 12 and eventually into the cashbox. It employs a pulley and belt mechanism to positively engage an unfolded bill, irrespective of condition. Acceptance of any of the above bills may be enabled/disabled by setting appropriate system parameters, which are programmable and downloadable from the farebox central system. Reprogramming to accommodate future bill types may require an EPROM change.

Processing time does not exceed two seconds per bill regardless of the denomination being processed, as measured from the time the bill started to be drawn into the acceptor until acceptance is made. Classified bills are transported to the driver-viewing window 12 and to the cashbox when the driver depresses the “Enter” button 32. The farebox 2 of the preferred embodiment accepts 95% of authentic bills on first insertion and 99% of authentic bills on second insertion. This classifying acceptance rate is the best level proven—or claimed—in the industry.

The farebox has an “accept next bill” function that allows the driver to manually accept a bill rejected by the classifier, but which on visual inspection is found to be valid. Upon activation of this feature by keypad command, the bill classifier accepts the next inserted item without classification and advances it to the cashbox. The bill mechanism then returns to normal classification mode. The “Accept Next Bill” feature can be limited to certain denominations or disabled. All uses of the feature are recorded by the farebox and uploaded to the farebox probing computer during probing.

The farebox employs a coin module to singulate and validate inserted coins with an inductive coin sensor such as the sensor disclosed in U.S. application Ser. No. 10/077,047, incorporated herein by reference in its entirety. The coin module is a removable, self-contained assembly fitted with appropriate polarized connectors to assure that electrical connections are made in a proper manner during the course of removal and replacement of the module. An internal view of the coin module is illustrated in FIG. 21. The coin module accepts, singulates, validates, and counts coins inserted at a rate of 10 coins per second and displays them to the driver in the coin viewing area. The input bezel 14 is mounted as part of the coin module, is funnel shaped, and finished in a natural aluminum color which contrasts with the top cover to assist passengers in its use. The cumulative amount of deposited monies is retained electronically and displayed on the DCU 4 and patron display 52.

The singulation portion of the coin module separates coins that have been inserted through the coin bezel and presents them, one at a time, to the registration array. Coins are accepted singularly or in groups. The singulator consists of three rotating parts: the singulation disc, singulator roller, and accelerator roller. Coin singulation is far superior to hand operated mechanical methods used by other farebox suppliers, as patrons are not required to insert one coin at a time, resulting in faster boarding times and passenger convenience.

The singulator disc is constructed of corrosion-resisting steel and rotates counterclockwise by means of a worm gear arrangement. When coins enter the singulator hopper, they are guided toward the singulator roller by the interior configuration of the hopper and the 60-degree angle at which the disc is mounted. The gravitational pull of the coins against the disc surface causes the coins to move with the rotation of the disc either singularly or in groups.

A rubber roller is positioned a set distance above the disc surface, rotating at the same velocity as the disc, but in the opposite direction. The precise position of this roller creates a gate through which two coins/tokens cannot pass at one time. The coin in contact with the disc surface is pulled along by frictional forces between the disc and coin surfaces and passes through the “gate” unobstructed. If two or more coins try to pass through the gate together, the top coins are pushed backwards by the counter-directional rotation of the high friction singulator roller surface. In this manner, each coin passes through the gate and is singulated from the remaining coins.

A second rubber roller is positioned next to the singulator roller and above the registration array. This roller rotates on an axis perpendicular to the singulator and at approximately twice the velocity. Its purpose is to move each coin exiting the singulator roller gate off the disc surface and into the registration array. The additional velocity is necessary to ensure that each coin has cleared the array before the next coin enters.

The inductive coin sensor identifies coins based on electronic signature. The coin signature is established by coin size, mass and metallic content. This is an improvement over past optical sensors that only measured the diameter of passing coins. The inductive coin sensor identifies the coin by comparing the measured coin signature with a programmed signature table. Each coin, due to its size, mass and metallic content produces a signature as it passes through the four inductive fields.

The inductive coin sensor processes coins at a throughput of ten coins per second. Coin singulation is performed by the farebox, so that patrons do not need to insert coins one at a time. At the 10 coins per second rate the inductive coin sensor has demonstrated an accuracy rate of better than 99%. In addition, the coin sensor does not accept slugs, cardboard, or plastic disks as currency. The inductive coin sensor does not require protective optical covers and is not affected by dust particles and lint from dirty coins. This feature makes the coin sensor more reliable and causes less road calls due to dirty sensors. The inductive coin sensor has the ability to execute a diagnostic bench check without having to be removed from the coin module.

Depending on the currency supplier, there may be significant variability in the coin signature due to differences in the metallic content. This variation is sometimes due to multiple suppliers of coinage using different metallic contents, or occasionally the same supplier using different contents over time. The classifying farebox 2 includes a secondary means of validation through the use of the farebox coin inspection plate which is viewable through a window 18. This affords the driver an opportunity to visually validate the deposited coins, after they have been processed by the coin sensor. This provides a second level of protection for all coins deposited for fare payment. Because of this inspection plate, the farebox does not require a coin return mechanism for dubious coins, which can significantly impact boarding times. Other bus authorities have required a coin inspection plate rather than a coin return cup because the Authority does not want to return fraudulent coins back to the passenger. Fraudulent coins are culled out and destroyed during the coin counting process at the money room. A description of the coin inspection plate and driver dump button is provided below.

Subsequent to insertion and classification, coins are directed to an illuminated inspection plate 18 on the farebox, where the coins are displayed in an upright position for driver viewing. The inspection plate 18 displays the coins separated from one another so they can be easily recognized and counted by the driver. This feature gives the driver the ability to settle any disputed amount deposited since the coins will be retained in the driver's viewing window.

Coins visible in this inspection area are automatically advanced to the cashbox (in the lower portion of the farebox 2) when a full fare is classified (dump time is a downloadable parameter); the driver depresses a “dump” push button; when the coins have been exposed in the display area for a specified length of time; or the number of inserted coins accumulates to fill the inspection plate.

The following actions occur when the driver presses a dump button, which may be assigned as a soft key 26, a function key 28, or the enter key 32: the coin inspection plate opens, causing the coins to automatically drop in the cashbox; and the total amount indicated on the DCU display changes to 0.00, the amount is added to the appropriate revenue registers, and the total value is stored in memory for later data retrieval.

For coins jams, the driver may select a coin dejam function from the DCU menu that will operate the coin motor alternately in the reverse and forward directions to attempt to dislodge the jammed coins. The coin mechanism is also provided with a manually operated dejam button 22 that widens the coin throat, permitting trapped coins to dislodge, and also causes the coin motor to operate in the reverse and forward directions as is done with the DCU dejam function. If these actions are not successful, the driver engages the coin bypass mechanism 20, as described above for all fareboxes. Coin bypass is recorded in DCU memory for uploading to the FPC.

Bill jam detection is automatic. If the bill transport jams, and the transport belt is stopped, bill acceptance is shutdown automatically. The driver then advises patrons not to insert additional bills. For magnetic fare cards the driver is provided with direct manual access to the ticket processing unit through a door 40 in the cabinet 2, where the jammed ticket can be removed. A DCU function may also be selected that operates the transport motor in an attempt to free the jammed media.

A patron display 52 in the form of a twelve character alphanumeric Light Emitting Diode (LED) display is positioned on top of the farebox 2 so that it faces the patron when boarding. The patron display 52 shows the value of the coins deposited, and is capable of displaying the status of fare media inserted (stored ride and pass status, etc.).

The DCU is equipped with an audio annunciator that can provide distinct and different audible signals for various conditions, such as: each time the amount displayed on the DCU display accumulates to equal the amount of the pre-set fare in use; each time any of the fare category push button keypad switches are depressed and the amount displayed on the DCU display has sufficient value to correspond with the value assigned to the push button depressed; when a tally push button has zero value; when function keys are used indicating a trip record; as acknowledgment that the driver has completed the log on procedure by entering his/her driver number, route number and run number; and as acknowledgment that the data has been uploaded properly via wireless data probing(s). The audio annunciator has a sound level of not less than 65 dB, with a volume control accessible to the bus driver. Tones can be modified and added to meet specific agency needs.

The internal farebox processor logic board contains a Motorola MC68332 microprocessor chip, or any equivalent microprocessor chip. The processor software is written as a stand-alone program and is not dependent on an operating system for services. This program consists of several source modules, typically one source module for each major device or function of the farebox. The processor contains 2 Kbytes of internal memory that is used for the program stack since this internal memory is substantially faster than external memory.

The controller printed circuit board contains a 256 Kbytes EPROM for the storage of the software. The software is estimated to require no more than 160 Kbytes to store the executable code and constant data necessary to perform its functions. This provides 96 Kbytes of EPROM capacity for future expansion. The watch dog timer is configured to strobe the microprocessor monitor every 1.2 sec. with a pulse width of approximately 500 ms. If the micro monitor does not receive this strobe, the reset lines are activated. The “power fail” signal is activated when bus voltage goes below 10V. This signal is sent to the micro monitor that initiates a reset to the time chip. While in “power fail” mode, all writes to memory are inhibited to protect the memory data.

The farebox memory circuit board contains 256 Kbytes of static memory for the storage of several categories of modifiable data required for operation of the farebox software. The memory circuit board also contains 2 Mbytes of pseudo-static memory for the storage of the farebox downloaded tables and accumulated transactions and bad card list. The memory is supported by backup battery with data retention capability of not less than 72 hours. The overall memory provision in the controller and memory circuit boards offers sufficient data storage capacity to store more than 150% of all required data, files, programs, fare tables, and hotlist required to support seven days of peak operation. When the capacity of the data storage exceeds approximately 75% of the total storage, a warning indication is given to the driver and a transaction record generated to record the event. The warning is kept on the DCU display. No other warning or transaction record is created until the data storage reaches 100% after which additional fare transactions are prohibited.

The cable connection to the bus power source is accomplished by means of a mil-spec polarized, self-aligning, self-locking, waterproof plug with positive retention screw or equivalent. The cable and interconnection design and manufacturing maintain superior standards to attain high reliability and maintainability. All internal sub-assemblies are interconnected by means of polarized positive plug connectors with self-locking. All plug-in components are retained with locking features to hold them firmly in position and to prevent getting loose against vibration. Wires and multi-conductor cables are colored coded and marked to permit positive identification.

The upper portion of the farebox is made of Type 302 or 304 stainless steel with a No.4 satin finish (non-glare, non-reflective), suitably reinforced with no external removable fasteners. A maintenance access lid is provided for the inspection and/or removal of farebox components located in the upper section. This door/lid is secured by means of a lock 56. Access to the farebox interior via this door/lid does not permit access to the collected revenue in the lower portion of the farebox.

The top casting/assembly provided on the upper portion of the farebox 2 has two entry slots including one for coins 14 and one for magnetic fare media 46. The coin slot 14 is shaped to direct inserted coins into the farebox and is sized no larger than that which allows 1.125-inch tokens to pass. Its design deters the entry of paper into the coin slot 14 and the formation of coin jams. Appropriate passenger information in the form of decals 16, 48 is provided to distinguish these slots from one another and to instruct (as may be required) patrons on how to use them.

The lower portion of the farebox includes a cashbox security door 62 with a continuous hinge and multi-point catches is provided to secure the cashbox within the farebox. The door 62 has an aperture for viewing the cashbox and easily seeing the serial number of the cashbox when the cashbox door is closed and locked. The security door has a labyrinth seal to deter insertion and use of prying tools. When closed, the security door fits flush with the adjacent surfaces of the lower portion of the farebox.

An electronic lock is used to secure the cashbox access security door and it engages the door automatically when the door is fully closed. Interlocks are provided so that the farebox is inoperative during the time in which the security door is “open.” The upper and lower portions of the farebox are securely fastened together by means of multiple bolts, accessible only from inside the farebox, and are installed with lock washers to assure a tight fit, which will not come loose under operational vibrations.

A base plate is affixed to the lower portion of the farebox to permit mounting the farebox to the vehicle floor in a highly secure manner while also allowing for the removal of the farebox in an expedient manner. After initial installation, removal of the farebox requires personnel to work inside the vehicle at the farebox only, and in most cases, does not require them to work under the vehicle. The base plate is designed to securely fasten the farebox to the vehicle. It does not present a tripping hazard for passengers boarding the vehicle and is compatible with all vehicles in the agency fleet. Provisions are made within the farebox for passage and strain relief of electrical wiring and ground strap.

The cashbox is constructed in a rectangular configuration to fit within the dimensions of the lower portion of the farebox 2 and is interchangeable among fareboxes. The cashbox retains coins in one compartment that provides 200 cubic inches of volume (this can accommodate up to $600 in coins). It has a grip handle to allow it to be easily removed, transported and inserted in a farebox. The mechanism and operation of the cashbox is positive and at no time during the revenue transfer cycle does it ever expose the interior of the cashbox or its contents. The interior of the cashbox affords complete discharge of coins/tokens in the revenue transfer cycle.

The cashbox fits into the farebox in a singularly correct position and is easily placed into the ready position to collect revenue. The cashbox insertion and removal procedure is designed to positively guide the cashbox into and out of the farebox. No ledges or other surfaces are present where coins may lodge and impede the operation of the mechanism. Under normal operation the farebox recognizes the presence of a cashbox properly engaged and ready for service. The absence of a cashbox properly engaged prevents the farebox from accepting coins until the cashbox is properly engaged.

The cashbox is equipped with an electronic ID, unique to each cashbox, which is read by the farebox and a receiver/vault when the cashbox is inserted. The cashbox remains locked unless it is in a farebox or receiver/vault. There is no unauthorized means of gaining entry into the cashbox other than destruction of the cashbox. Such destruction would be noticeable through quick visual inspection and would prevent the cashbox from being inserted into or working in a farebox. The cashbox is designed with a high level of security, requiring the presence of security key(s) to allow it to be opened in an authorized manner. Operation of the cashbox is such that it is in a closed, locked and sealed condition whenever it is out of the farebox or receiver/vault.

The farebox is provided with a sensing device, capable of continuously monitoring the presence of a cashbox in the farebox. If the sensor detects that a cashbox is removed without the farebox having been probed, an alarm message, containing the date and time of removal, is generated and stored in the farebox memory. The next time the farebox is probed, the data upload will contain a “cashbox alarm” indicating the date and time of the alarm.

The cashbox volume threshold, (percent full) is a pre-settable parameter downloadable from FCS. This parameter advises the driver that the cashbox contents have reached a specified volume level, which in turn may result in the driver taking the bus to the garage for probing and removal and emptying of the cashbox. The cashbox full amount is a fixed parameter determined by the size of the cashbox. When the cashbox content is full, a warning indicator is displayed until after the farebox is probed and the cashbox is extracted. After the cashbox is extracted, the cashbox amount register is cleared to zero to reset the indicator.

The farebox operates from the vehicle power supply and is protected against damage, loss or modification of data caused by: lower or higher voltage, and reverse polarity of input voltage. The farebox power supply includes adequate filters and components to regulate the supply voltage and render it devoid of power spikes and noise, which could contribute to erroneous registration, data generation and recording, or equipment failure. Provisions include the elimination of electronic interference caused by such items as fluorescent light power units, alternators, air conditioning units, radio communication units, automatic passenger counters, bus locator equipment, etc. Adequate protection against transient surges on the vehicle power supply is incorporated to the extent necessary to prevent damage to electronic components and the corruption of data.

The power to the farebox runs through a polarized connector at the bottom of the farebox. The connector provides for positive locking to ensure a secure connection. The location of the connector is convenient for easy connect/disconnect by Authority personnel. A manually operated on/off switch is provided to control the power to the farebox. It is accessible by authorized personnel only. The switch is rugged in construction and has two positions (ON/OFF). It is clearly labeled so that the handle position points to, or is aligned with, the conditions indicated by the label.

The classifying farebox unit 2 utilizes the driver control unit (DCU) 4 as the single point of driver interface for all on-board systems. As a result, the farebox communicates with the DCU via a serial connection. This connection enables the DCU keypad 34 and display 6 to act as the driver interface for farebox functions. In addition audible tones are generated by the DCU based on farebox transaction sequences. The farebox also communicates with the Farebox Probing Computer via wireless probing for data transfer and the inductive probe to provide access to the cashbox.

Communications with the farebox probing computer is via wireless data transfer and inductively coupled probe at 230 KBPS and with Portable Probe via a RS-232 serial port. The standard of data communication used are as follows: RS-232 to Portable Data Probe and Destination sign, and RS-485 to Driver Control Unit.

The DCU provides the primary driver interface for data collection, status monitoring, and control of the onboard fare collection system and transit management devices. During a typical shift the driver uses the DCU to accomplish the following tasks:
Log on at the beginning of the shift;
Adjust DCU volume and lighting;
Place the farebox system into service by entering specific route information;
Support patron cash, magnetic card/transfer/pass, and smart card transactions;
Place system temporarily out of service for personal breaks; and
Log out at end of shift.

The DCU, illustrated in FIG. 5, acts as a single vehicle control head providing the driver display 6, soft key 26, and numeric keypad 34 interface for the card interface device, farebox, and the CAD/AVL Bus Management System. The DCU includes a monochrome graphic 4.7-inch diagonal liquid crystal display (LCD). Resolution of the LCD is ¼ Video Graphics Adapter (VGA) with 320×240 dot matrix. The backlight, brightness, and contrast are adjustable. The vertical angle of the display can be adjusted via the DCU mounting features such that the incident sunlight effects are reduced to a minimum.

The DCU keypad contains twelve soft keys 26. Four are located at each side of the LCD display 6 and four are along the bottom. Soft keys 26 are identified by the >, <and \hat{ } symbols. The functions of the soft keys 26 are programmable and downloadable from the FCS and will vary between screens for logon, driver, and maintenance operations. The particular function of the soft keys 26 will be displayed on the LCD next to each key.

Continuing with FIG. 5, four special function keys 28 are located at the second row below the LCD. These keys include the RTT (Request To Talk), PRTT (Priority Request To Talk), HOME, and T/A (Transit/AFC). These keys are used with the optional Bus Management System devices.

The DCU keypad contains twelve numeric keys 34 consisting of 0 to 9, *, and the # sign. See FIG. 5. During revenue operation the 0 and 8 keys have the following predefined functions: 0 “HOLD” extends a transaction timeout, and 8 “DEJAM” initiates a coin dejam sequence. The DCU keypad contains one large ENTER key 32 which accepts driver-entered values during driver log on, trip configuration, and maintenance codes. “DUMP” terminates a transaction before it would normally timeout during revenue operation. Coins will no longer be counted and will fall directly into the cashbox. The navigation button is utilized to move the display cursor from field to field in any of the four directions. The <key clears an entered value in any trip configuration and maintenance screen.

As shown in FIG. 6, the smart I/O unit 90 is used as an I/O expansion to add additional serial and parallel ports to the DCU. There is no data processing in the smart I/O unit. The DCU and smart I/O unit communicate with each other through the Universal Serial Bus (USB) port 94. Other external devices would be attached through the other connectors 92, 96. These ports support standard interface specifications including J1708, RS232, and RS485. The smart I/O unit enclosure is permanently fitted to the bus. Use of the smart I/O unit facilitates easy removal of the DCU from the bus for maintenance, upgrade, and repair when multiple devices are monitored and controlled by the DCU.

As previously mentioned, the DCU provides the primary driver interface for log on, data collection, status monitoring, and control of the on board fare collection system and transit management devices. During a typical shift the driver uses the DCU to accomplish the following tasks:
Log on to all on-vehicle equipment/subsystems at the beginning of the shift;
Adjust DCU volume and lighting;
Place the farebox system into service by entering specific route information;
Support patron cash, magnetic and smart card, and transfer transactions;
Place the system temporarily out of service for personal breaks and;
Log out at the end of a shift.

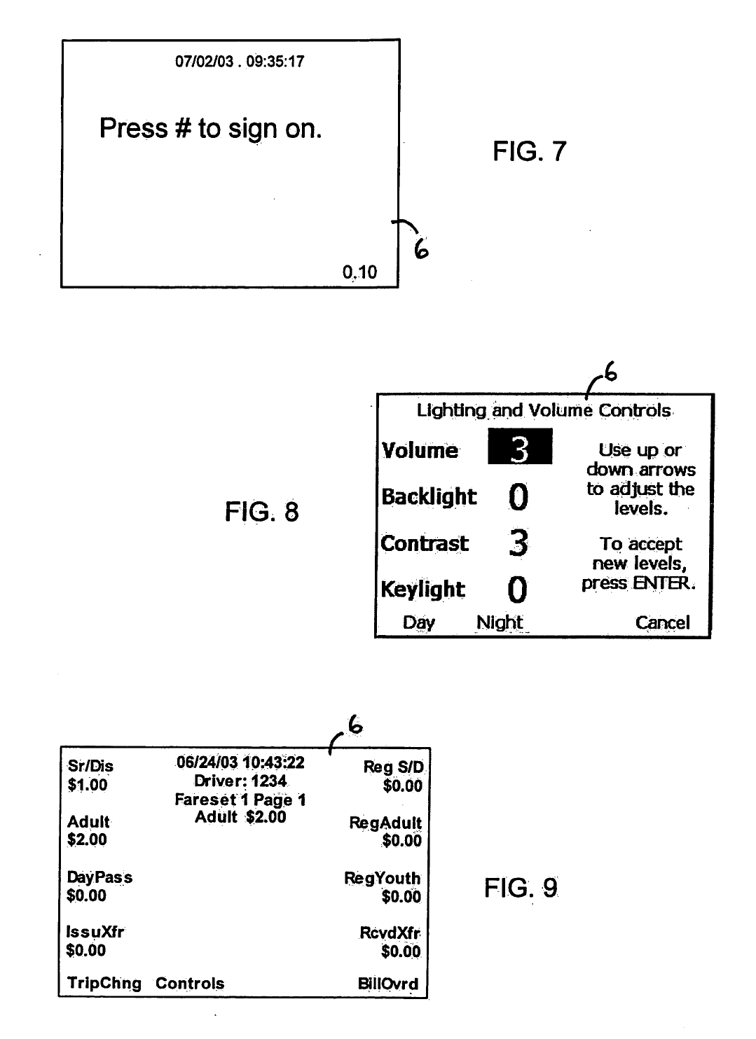

The driver must log on before the DCU becomes operational, see FIG. 7. Log on is accomplished depressing the # key on the numeric keypad or touching an employee smart card to the target antenna. As a result of this action the DCU displays a screen prompting the driver to enter his/her Personal Identification Number (PIN) using the numeric keypad. When a smart card is used for log in this information is entered automatically. Depressing the ENTER key completes the log in process and causes the DCU to continue prompting the driver for additional information, (route, run, fare set, etc.). The ENTER key is depressed once again to cause the system to accept the inputs and place the vehicle in revenue service.

Depression of the “Controls” soft key results in display of the lighting and volume control screen, see FIG. 8. The driver depresses the “day” or “night” softkeys to set predefined display values. When a specific item needs to be changed, the driver depresses the button next to the control to be changed and follows the instructions on the display to vary the value to the desired level. Depression of the ENTER key causes the data entered to be accepted.

Cash fare transactions are possible only when a farebox is installed on the bus and configured with the DCU. The default fare is always active. The default fare is considered the full fare in the following paragraphs. When a patron inserts cash into the farebox the DCU mirrors the farebox display. The value displayed is the remaining value to be inserted to complete the transaction at the selected fare. For example when a patron inserts $0.75 towards a full fare ($2.00) the display shows “1.25”. This is the amount the patron must yet insert to complete the transaction at the fun fare rate.

The main revenue screen is shown in FIG. 9. No driver action is required for default fares paid with cash. As the cash is inserted the farebox notifies the DCU. The remaining amount owed is displayed below the default fare amount until the fare is reached. The farebox does not provide change to the patron when more than the required fare has been deposited. The driver may depress the designated HOLD key (0 key) to extend a transaction timeout period, allowing the patron additional time to insert more money. Depression of the designated DUMP key (ENTER ( )) terminates a transaction before it would normally timeout. The DCU and farebox displays are then set to zero. The transaction timer is reset when a bill, coin, or token is inserted into the farebox.

Using the main revenue screen, the driver depresses the softkey corresponding to the desired fare and observes that the screen is appropriately updated with the selected fare description. The active fare is restored to the current default fare once the transaction timeout expires.

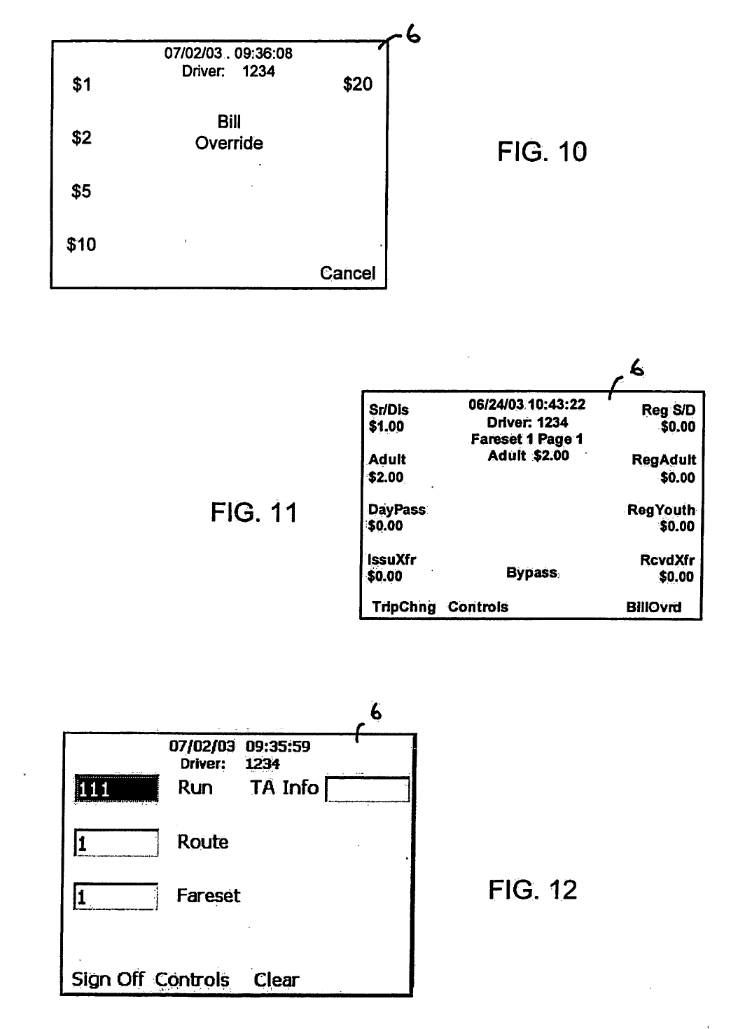

When a bill is rejected by the farebox the driver depresses the “bill override” softkey, which causes display of the bill override screen, see FIG. 10. The driver then depresses the appropriate softkey to reclassify a bill as $1, $2, $5, $10, or $20. To cancel the operation before the bill has been inserted, the Cancel key is depressed and the DCU returns to the prior screen. The next bill inserted is accepted unconditionally and the override count is incremented and classified as selected by the bus driver. The DCU reverts to automatic operation after one bill has been accepted. The same procedure is followed for each bill that requires an override.

To place the farebox in “bypass mode” the driver pushes down the farebox bypass lever and verifies that the DCU display is reporting that the farebox is in bypass mode. See FIG. 11. Any coins in the farebox pass directly into the cashbox. Coins deposited from that time on will not be counted.

Magnetic tickets, used for transfers, are encoded and printed with relevant transfer information. To issue a transfer, the driver simply depresses the “issue transfer” softkey. To accept a transfer, the patron inserts the transfer into the farebox ticket bezel where it is automatically read and its validity verified. Ensure that the ticket is properly oriented with the magnetic stripe on the left side of the ticket facing the driver. Transfer Failure. If the magnetic processing unit cannot read a transfer ticket the driver visually verifies the transfer validity and depresses the soft key designated for accepting patrons with valid tickets that cannot be read.

When the driver wishes to log off the DCU he/she depresses the “Trip Change” softkey, which causes display of the trip change screen, see FIG. 12, followed by depression of the “Log Off” softkey. An automatic log off occurs when there is no keyboard activity for a configurable period of time, when the system is out of service, or when farebox data probing is initiated. The screen will return to the logged off idle screen illustrated in FIG. 8. If the system is in revenue service, it will go out of service. A status change message and Bus Farebox System message will be generated noting that the driver has logged off.

Fare schedules are provided in the fare collection system. Each fare set contains a pre-set fare amount, fare for each key entry, and fare for various types of magnetic fare cards. The selection of the operating fare schedule can be achieved by manual keypad entry. The driver also selects the destination code ridership and revenue corresponding to particular destination codes as presented in the fare collection system. Fare schedules are maintained at the FCS and are downloaded to the DCU via the FPC during probing. A fare schedule may be set to “express” or “normal” service. Within a fare schedule, each key and farecard type has fare values for use during peak and off-peak times.

The route/run segment record is in the form of audit records. The records are created whenever the driver places the onboard system into service or changes the fareset or destination code. New audit records are also being created when there is a transition between peak and off-peak service, when bypass begins, when midnight occurs, or when a field in a record would overflow. Should the magnetic ticket processing unit enter a degraded mode of operation, such as read-only, a new audit record is automatically created. The Authority may set hourly creation of audit records through an FCS table for further segmentation. Status Change records instead of audit records are created by the farebox, since the farebox is not in revenue service under the following conditions:
Removed from bypass,
Cashbox removed,
Cashbox inserted,
Access door opened,
Access door closed, or
Probing.

Probing is accomplished by using a wireless data transmission capability and a manual inductive operation. No action is required by the driver to perform the probing process. Wireless probing occurs when the bus arrives at the garage and enters the area covered by the Wireless Access Point (WAP). During probing the DCU uploads revenue data to the FPC and downloads new data from the FPC, (e.g., fare tables, operational data, configuration data, etc.). When the farebox is manually probed the driver is automatically logged-off if he/she has not already done so.

Inductive probing occurs when an inductive probe is manually applied to the farebox. Revenue collection personnel perform this operation. During the operation, the farebox is unlocked and the cashbox removed. The DCU will automatically log off during manual probing, as it would for other farebox configurations. Cabling is provided to link the inductive probe and receiver/vaults with the FPC. The number of conductors in the transmission cable is consistent with transmission requirements. Cables for access up to five channels of polled data collection lines are provided. The conductors are appropriately shielded and jacketed to minimize effects of electrical noise and for protection against the hostile environment, as defined above.

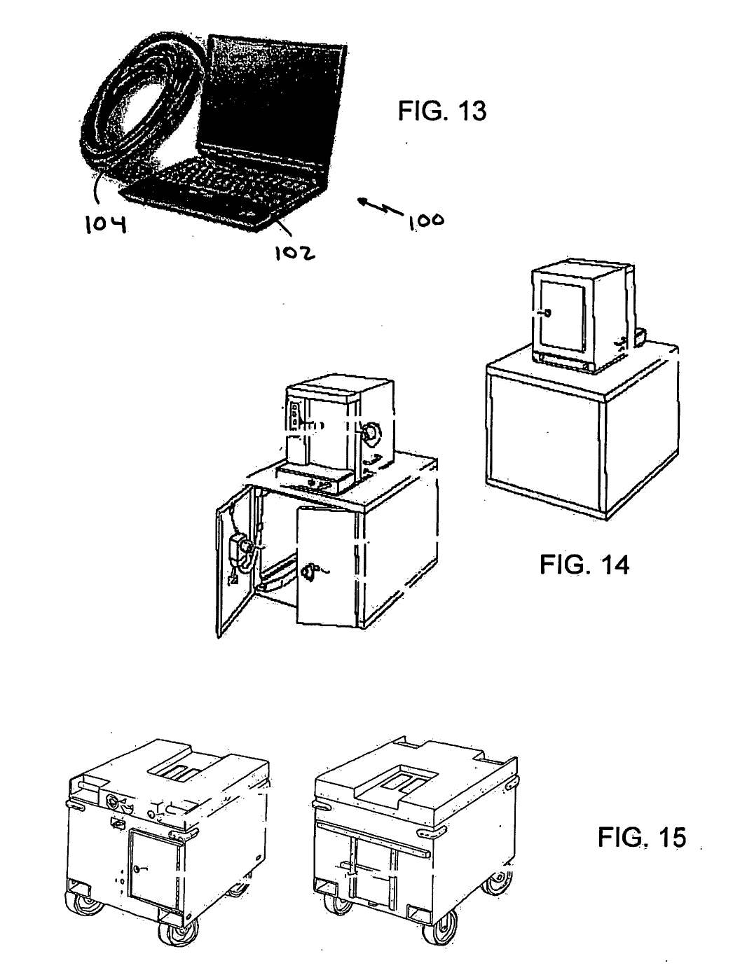

As shown in FIG. 13, a portable probe 100 is provided as a back-up provision for each FPC and for use in event of a power loss at the garage depot. The portable probe 100 performs the function of a fixed probe 104 with a laptop computer 102. When the portable probe 100 is engaged with the farebox, all messages are transferred and an audible tone is sounded to indicate the probing cycle is complete. The portable probe 100 closes out the file upon selection of the “exit” and “close” function. All interaction with a portable probe is separately identified with the portable probe number. A data port is provided in each FPC to provide for the downloading of portable probe data. The FPC software provides for the merging of portable probe and FPC data.

The receiver/vault, illustrated in FIG. 14, accepts a cashbox, and by means of a mechanism operated in a highly secure manner, opens the cashbox and discharges its contents into the mobile vault located in the lower half of the receiver/vault enclosure. The receiver/vault is connected to the FPC in order to transmit mobile vault and cashbox serial numbers. Completely emptying a full cashbox in the receiver/vault takes no longer than fifteen (15) seconds as measured from the time the cashbox is positioned in the receiver vault to the time when it is withdrawn from the receiver/vault.

The receiver/vault is constructed of heavy-duty plated steel and is anchored to the floor by means of anchor bolts. The receiver/vault is designed to resist forced unauthorized entry. Heavy duty is defined as the degree of sturdiness incorporated in the design to withstand the daily operational strains anticipated for the equipment used to perform its specified functions. The opening into which the cashbox is inserted is constructed of materials able to sustain high wear resistance and is durable under rough handling conditions. Stainless steel is used for the interior lining of the receiver/vault, and all front surfaces including the enclosure doors that open and close to permit removal and replacement of the mobile vault.

The lower portion of the enclosure has steel guides to properly position the mobile vault. These guides are constructed of high wear-resistant, durable steel. All doors are structurally rigid with heavy-duty hinges. The mobile vault enclosure is resistant to the entry of water. All surfaces and edges are ground smooth with all corners appropriately rounded. There are no exposed bolt heads, nuts or sharp edges on the exterior surface.

The receiver/vault accepts a cashbox in a unique orientation to enable the revenue-emptying procedures to take place. Once the cashbox is inserted in the proper manner the heavy-duty door with interlock is closed and locked. Cashbox emptying takes place only when the door is locked, all other interlocking conditions have been satisfied, and a handle is pulled to open the cashbox lid allowing coins to drop into the mobile vault.

A visual indication is provided near the receiver/vault door to signify when a cashbox is emptied and ready for removal. A separate visual indication is provided to signify when the revenue transfer process is in progress and when the cashbox is not ready to be removed. The door remains locked until the “ready” indication is achieved. The receiver/vault identifies each cashbox by electronically sensing the serial number encoded in each cashbox. The receiver/vault has a number of interlocking and security features. For example, the receiver/vault does not operate unless a mobile vault is in position and properly seated within the receiver vault enclosure. When any door of the receiver/vault housing is open, the receiver mechanism that empties the cashbox and the handle that opens the cashbox lid are in the inactive mode. When the cashbox is properly positioned in the receiver unit and the receiver door is closed, the handle cannot be pulled partially and returned to the starting position.

Once the cashbox is inserted and the door closed, the handle must be fully pulled so that a complete emptying cycle can be executed before the cashbox can be removed. When the handle is fully pulled to the “emptying” position, the emptying cycle starts and a minimum time delay of 5 seconds is initiated to allow emptying of the money by gravity. During the emptying cycle a visible indication is provided, (red light). When the emptying cycle is complete, the “emptying” indication is discontinued and a cycle-complete indication, (green light), is provided. The lights are located high enough on the receiver vault and bright enough to be readily seen on monochrome CCTV displays. The 5-second delay period is field adjustable. When the delay period is satisfied, the cashbox is completely closed before the interlock logic indicates a “ready” state to permit the door to be opened and the cashbox to be removed. When a jam occurs, the receiver vault retains its security except for access by authorized personnel. Appropriate maintenance access apertures are provided. Each of these are protected with a high security locking system. All elements of the interlocking system are integral to the receiver/vault. All engagements and alignments are positive and automatic.

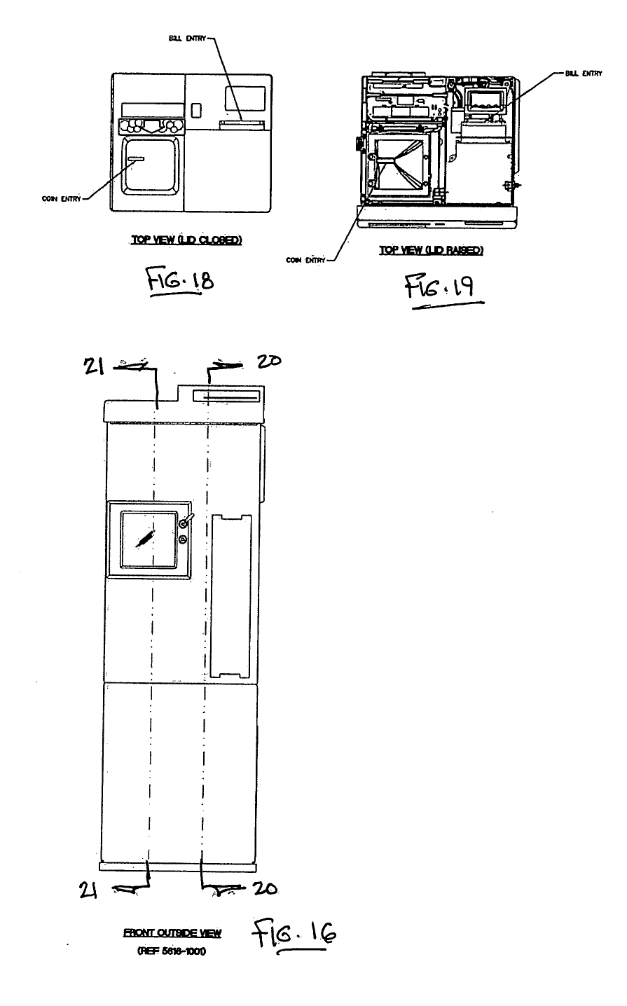

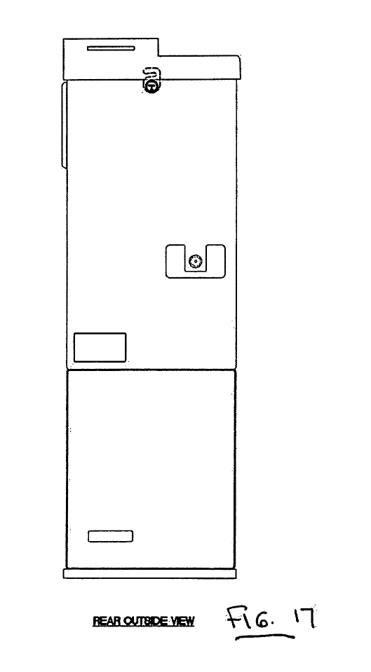

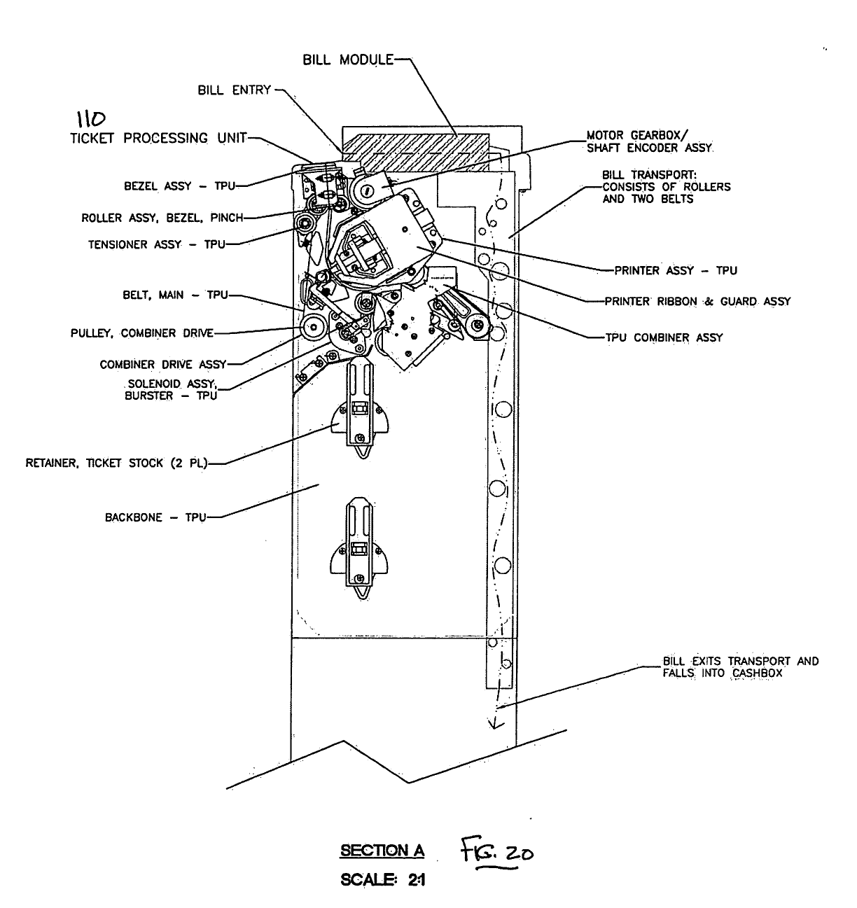

The mobile vault contains a coin compartment that is emptied by opening an access door to permit the coins to fall (by gravity) into a container. When removed from the receiver vault enclosure, the mobile vault is in a closed and locked condition. Means are provided to tie down the mobile vault to a revenue truck. The mobile vault is shown in FIG. 15. Completely emptying a full cashbox in the receiver vault takes no longer than 10 seconds when measured from the time the cashbox is positioned in the receiver to the time it is withdrawn from the receiver. The mobile vault is constructed of heavy-duty steel and assembled as to not allow access to the contents other than through authorized protected apertures. Appropriate maintenance apertures are provided, each secured with a high security locking system. The mobile vault is mounted on four wheels; two fixed and two with 360-degree swivel so as to facilitate maneuvering of a fully loaded mobile vault.

A “deadman” braking system is provided to engage brakes on the two fixed wheels so that a fully loaded mobile vault can be held in stationary position on a 6-degree incline. Provisions are included in the design to permit the mobile vault to be lifted by a forklift truck in a safe manner. Channel guide structure for the forklift is designed for full load conditions with appropriate safety factors, enabling rapid transfer of the mobile vault into a revenue truck.

The interior design of the mobile vault prevents entrapment of coins. The design of each compartment is such that it facilitates easy removal of its contents. Doors to open each compartment for emptying of contents have concealed or capped heavy-duty hinges and high security locks. The ability to unlock and open these doors with ease takes into consideration force exerted by a fully loaded coin compartment against the locking mechanism. All surfaces and edges are ground smooth with all corners appropriately rounded. There are no exposed bolt heads, nuts or sharp edges on the exterior surface.

The mobile vault is designed for insertion, in a unique orientation, into the lower portion of the receiver/vault enclosure, located below the cashbox receiver. Once the mobile vault is properly positioned within the enclosure, the cover doors properly closed and locked, and all other interlocking conditions met, the cashbox receiver is ready to accept a cashbox. This is evident by the indication on the receiver. Removal of the mobile vault is accomplished by opening the receiver/vault access doors and rolling the mobile vault out.

The overall size of the mobile vault does not exceed 84 cm wide by 107 cm deep by 99 cm high. The tare weight does not exceed 275 kgs. The following interlocking and security features are provided:
The cashbox receiver does not operate unless the mobile vault is in position and properly seated within the receiver vault enclosure;
The opening(s) in the mobile vault through which money from the cashbox is accepted, remain closed until a cashbox is inserted into the receiver unit, the receiver door closed and the handle pulled to initiate an emptying cycle;
The mobile vault cash accepting openings are automatically closed and locked, when the receiver/vault enclosure doors are opened, to prevent access to its contents; and
It is not possible to access the contents of the mobile vault, (by fishing or other means), when the receiver unit door is open and no cashbox is present. The mobile vault cash accepting openings are always closed and locked when no cashbox is being emptied.

As was previously mentioned, when the bus arrives at the garage depot and enters the wireless transmission area it is automatically probed. As a result of the wireless probing action, transaction and other data are uploaded from the farebox to the FPC and all appropriate data, (date, time, fare tables, hotlist, etc.), are downloaded from the FPC to the farebox. When the bus arrives at the revenue-processing island, it is probed once again using the fixed probe, the farebox door is opened, and the cashbox is removed and inserted into the receiver/vault for emptying. Once emptied, the cashbox is replaced in the bus farebox, from where it was taken, and the farebox door closed.

The Bus AFC System maintains an audit trail of cashbox movement and cashbox content by cashbox ID. Features, inherent in the system design, which support the maintenance of a secure audit trail, are as follows. Built-in features in the system enable support the secure revenue audit trail. For example, each cashbox contains a unique electronic ID readable by the farebox, the farebox reads the cashbox ID upon insertion, and records all revenue deposited into the cashbox. The farebox transaction and other data are transmitted to FPC during wireless probing. The receiver/vault reads and transmits cashbox ID, date, and time to FPC. Finally, the FPC data processing establishes a database containing all bus transactions and revenue received by date and time for each cashbox ID and generates the reports, (revenue, ridership cashbox audit, etc.) required by transit management to optimize bus system operation.

Performance of the receiver/vault and the cashbox measured by the time period taken for a full cashbox in the cashbox receiver to completely remove all coins and tokens into the mobile safe will be no more than 10 seconds. This period is measured from the time the cashbox is inserted and positioned in the cashbox receiver vault to the time when the cashbox is removed from the cashbox receiver vault.

At step 200 money or a ticket is inserted into the classifying farebox. The box, based upon where the money or ticket is inserted, determines what the patron has inserted. For example, if the patron has inserted coins into the coin bezel, the system will know to utilize the coin processing unit in the classifying farebox. Likewise, if the patron inserts bills or a bill into the entry bezel 10, then the classifying farebox knows to utilize the bill classifying module. Likewise, if a ticket is inserted, the classifying farebox knows to utilize the magnetic processor unit. If a coin is inserted then at step 202, as described above, an inductive coin sensor may be utilized to determine the metallic content of the coin. Likewise, the diameter of the coin may be measured at step 204 to determine the authenticity of the coin. In addition, as described above, the driver may utilize a visual check at step 206 to further yet validate the authenticity of the coin inserted by the patron. Any one, or all of these validating characteristics may be utilized to determine the authenticity of the coin currency inserted by the patron. A decision is made at step 208 whether valid coin currency has been inserted by the patron. If the decision has been made at step 208 that the coin currency is valid, then the coin currency may be advanced to the cash box at step 210. If a decision is made at step 208 that the coin currency is not valid, then at step 212 an instruction may be provided to the patron to insert valid currency and the currency may be returned to the patron.

If it is determined that a bill has been inserted into the classifying farebox, then the length of the bill may be measured at step 214 to determine the authenticity of the bill currency inserted by the patron. At step 216, a visual check may be conducted by the driver to determine whether the bill currency is authentic. If a determine is made at step 218 that the bill currency is not valid, then as shown in step 212, an instruction may be provided to the patron to insert valid currency and the currency inserted by the patron may be returned. At step 220 the bill currency may be advanced to the cash box if a decision is made at step 218 that the bill currency is valid. At step 222 the driver may register the amount of the bills inserted, such as if the patron inserted a $10 or $20 bill and the fare is less than the amount inserted. If so, at step 224 change may be provided to the patron.

If a ticket is inserted a determination is made at step 226 whether a valid ticket has been inserted by the patron. If a valid ticket has been inserted into the classifying farebox, then at step 228 the ticket may be processed through the validating farebox and at step 230 the appropriate fare may be deducted from the ticket. At step 232 the ticket may be returned to the passenger if there is excess value remaining on the ticket. At step 226 if it is determined that the ticket is not valid, then at step 234 instructions may be provided to the patron to insert a valid ticket and the invalid ticket may be returned to the patron.

Although a preferred embodiment of the invention has been described above by way of example only, it will be understood by those skilled in the field that modifications may be made to the disclosed embodiment without departing from the scope of the invention. For example, the present classifying farebox is described herein as in being utilized in a mass transit system, however, the classifying farebox of the present disclosure may also be utilized in a parking lot or parking meter situation. In either one of these situations the classifying farebox would allow for the prepayment of a parking spot by either the use of currency or a smart card.

1. A classifying farebox unit that accepts, processes and validates coins, classifies bills by denomination, and processes magnetic and smart card fare media, comprising:
a housing;
a magnetic processor unit located in the housing for processing magnetic tickets;
a smart card processor unit located in the housing for processing smart cards;
a bill classifying unit for classifying bills in different denominations; and
a coin processing unit to singulate coins.

2. The classifying farebox unit of claim 1, wherein the housing further includes a ticket bezel for accepting tickets into the magnetic processor unit located in the housing.

3. The classifying farebox unit of claim 1, wherein the housing includes a target antenna on the exterior surface of the housing for receiving signals from a smart card.

4. The classifying farebox unit of claim 1, further including a bill bezel located at an outer surface of the housing for accepting bill currency into the bill classifying unit.

5. The classifying farebox unit of claim 1, further comprising a coin bezel located on an exterior surface of the housing for accepting coins into the coin processing unit.

6. The classifying farebox unit according to claim 1, further including an inspection window for visual identification of currency inserted into the classifying farebox unit.

7. The classifying farebox unit according to claim 6, wherein the currency window provides visual identification of coin currency inserted into the classifying farebox unit.

8. The classifying farebox unit according to claim 6, wherein the currency window provides visual identification of bill currency inserted into the classifying farebox unit.

9. The classifying farebox unit according to claim 6, wherein the currency window provides visual identification of coin and bill currency inserted into the classifying farebox unit.

10. The classifying farebox unit according to claim 6, further comprising a driver control unit adapted to be executed by the driver for accepting fares deposited and for providing messages to patrons.

11. The classifying farebox unit according to claim 6, the coin processing unit further comprising a coin bypass, wherein coins inserted into the classifying farebox unit are displayed in the currency window to permit the driver to view and verify or count coins deposited into the classifying farebox unit when the coin processing unit is jammed or unoperational.

12. The classifying farebox unit according to claim 6, wherein the coin processing unit further comprises a de-jam mechanism to loosen coin jams in the coin processing unit and which starts an automatic de-jam function within the coin processing unit.

13. The classifying farebox unit according to claim 1, wherein the magnetic processor unit validates, encodes, and prints magnetic tickets.

14. The classifying farebox unit according to claim 10, wherein the smart card processor communicates transaction data to the driver control unit for retention and for transferring transactional information to a central computer system.

15. The classifying farebox unit according to claim 6, wherein the bill classifying unit accepts bills in any orientation and classifies the bills by denomination and further can identify, count, and securely store paper currency based on optical or magnetic characteristics.

16. The classifying farebox unit according to claim 6, wherein the coin processing unit accepts coins either singularly or in groups.

17. The classifying farebox unit according to claim 16, wherein the coin processing unit further includes an inductive coin sensor that identifies coins based on an electronic signature.

18. The classifying farebox unit according to claim 17, wherein the coin processing unit further identifies coins based on coin size, mass, or metallic content.

19. The classifying farebox unit according to claim 6, further comprising an illuminated coin inspection plate where coins are displayed in an upright position adapted for driver viewing.

20. The classifying farebox unit according to claim 6, wherein an electronic lock is used to secure access to a cash box used to store currency deposited into the classifying farebox unit.

21. The classifying farebox unit according to claim 10, further comprising means for the driver control unit to communicate with a computer for data transfer of information from the driver control unit to the computer.

22. The classifying farebox unit according to claim 10, wherein the driver control unit includes means for wireless data transmission capability for transferring transactional and revenue data to a central computer.

23. A farebox system, comprising:
a classifying farebox unit that accepts, processes and validates coins, classifies bills by denomination, and processes magnetic and smart card fare media, wherein the classifying farebox unit comprises:
a housing;
a magnetic processor unit located in the housing for processing magnetic tickets;
a smart card processor unit located in the housing for processing smart cards;
a bill classifying unit for classifying bills in different denominations;
a coin processing unit to singulate coins; and
an inspection window for visual identification of currency inserted into the classifying farebox unit; and
a central computer system for communicating with the classifying farebox unit regarding revenue collection and other data relating to the classifying farebox unit.

24. The farebox system according to claim 23, wherein the classifying farebox unit and the central computer communicate via wireless communications or a cable linked between the classifying farebox unit and the central computer.

25. The method of accepting, processing, and validating media used in a mass transportation system, comprising the steps of:
determining the type of media inserted into a classifying farebox, if the media is at least one coin, determining the validity of the coin by either inductive coin sensor, measuring the coin diameter, or visual identification of the driver;
if the media is at least one bill, determining the validity of the bill by either measuring the length of the bill, or visual identification of the driver;
if the media is a ticket, determining the validity of the ticket and deducting the fare from the ticket; and
advancing the media to either a cash box or a ticket container.

26. The method of accepting, processing, and validating media used in a mass transportation system according to claim 25, further comprising the step of communicating data from the classifying farebox to a central computer so that data relating to revenue collections may be collected and analyzed.

27. The method of accepting, processing, and validating media used in a mass transportation system according to claim 26, wherein the step of communicating data from the classifying farebox is accomplished by either wireless communications or a cable link between the classifying farebox and the central computer system.
